(19) United States
(12) Patent Application Publication
(10) Pub. No.: US 2026/0124719 A1
(43) Pub. Date: May 7, 2026

(54) Ratchet Wrench

(71) Applicant: Chien-Ying Lee, Taichung City (TW)

(72) Inventor: Chien-Ying Lee, Taichung City (TW)

(21) Appl. No.: 18/938,356

(22) Filed: Nov. 6, 2024

(51) Int. Cl. B25B 13/46

(52) U.S. Cl. CPC B25B 13/463

(57) ABSTRACT

A ratchet wrench includes a wrench body, a ratchet wheel, a pawl member, an elastic member, and a restriction member. The wrench body has a first receiving recess and a second receiving recess. The ratchet wheel is rotatably mounted in the first receiving recess and has a ratchet portion and a mounting portion. The pawl member rests on a side of the second receiving recess and has multiple engaging teeth, a first protruding block, a first face, a second face, and a third face. The engaging teeth engage the ratchet portion. The restriction member has a fourth face, a fifth face, and a receiving chamber. The first protruding block and the elastic member are received in the receiving chamber. The elastic member is elastically biased between the pawl member and a wall of the receiving chamber.

### BACKGROUND OF THE INVENTION

### Field of the Invention

The present invention relates to a hand operated tool and, more particularly, to a ratchet wrench.

### Description of the Related Art

A conventional ratchet wrench was disclosed in the U.S. Pat. No. 8,272,297, and comprises a handle 10, a detent 20, and a socket 30. The detent 20 includes an arcuate block 21, a spring 22, and a movable pawl 23. The arcuate block 21 is provided with a wing plate 211 and a cylindrical hole 212. The movable pawl 23 is provided with a pin 231.

However, the conventional ratchet wrench has the following disadvantages.
1. The arcuate block 21, the spring 22, and the movable pawl 23 are connected serially. The spring 22 is connected between the arcuate block 21 and the movable pawl 23. The spring 22 is a soft structure so that the arcuate block 21, the spring 22, and the movable pawl 23 have a soft connection. The movable pawl 23 has a first side abutting the wing plate 211 of the arcuate block 21 and a second side distant from the wing plate 211 of the arcuate block 21. The user's hand cannot hold the arcuate block 21, the spring 22, and the movable pawl 23 simultaneously, so that the arcuate block 21 or the movable pawl 23 easily slip from the user's hand. Thus, the arcuate block 21, the spring 22, and the movable pawl 23 are not assembled easily.
2. The spring 22 is mounted between the cylindrical hole 212 and the pin 231. In assembly, when the operator wishes to assemble the spring 22, the first end of the spring 22 is inserted into the cylindrical hole 212 by the operator's one hand, and the first end of the spring 22 is mounted on the pin 231 by the operator's other hand, so that the conventional ratchet wrench is not assembled conveniently.
3. The arcuate block 21 is provided with the cylindrical hole 212, and the movable pawl 23 is provided with the pin 231, thereby increasing the working cost of the conventional ratchet wrench.
4. The arcuate block 21 is formed with the wing plate 211 by metal injection molding. The wing plate 211 is a thin sheet plate and is not formed easily so that the upper and lower dies of the arcuate block 21 are made thin to fit the wing plate 211. Thus, the upper and lower dies of the arcuate block 21 are not made easily, thereby increasing the cost of fabrication.

### BRIEF SUMMARY OF THE INVENTION

The primary objective of the present invention is to provide a ratchet wrench whose parts are assembled easily and conveniently.

In accordance with the present invention, there is provided a ratchet wrench comprising a wrench body, a ratchet wheel, a pawl member, an elastic member, a restriction member, and a snap ring. The wrench body is provided with a first receiving recess, a second receiving recess, and a first peripheral face. The ratchet wheel is rotatably mounted in the first receiving recess and is provided with a ratchet portion and a mounting portion. The pawl member is received in the second receiving recess and rests on a side of the second receiving recess. The pawl member is provided with multiple engaging teeth, a first protruding block, a second protruding block, a first face, a second face, and a third face. The elastic member is received in the second receiving recess and elastically presses the pawl member, so that the engaging teeth meshes with the ratchet portion. The restriction member is provided with a fourth face, a fifth face, and a receiving chamber. The receiving chamber has a closed top and a closed bottom. The first protruding block and the elastic member are received in the receiving chamber. The elastic member is elastically biased between the pawl member and a wall of the receiving chamber.

According to the primary advantages of the present invention, the pawl member is provided with the first protruding block assembled in the receiving chamber of the restriction member, so that the pawl member and the restriction member are connected. The pawl member, the elastic member, and the restriction member are assembled previously and are then mounted in the wrench body. Thus, when the user's hand holds the pawl member, the elastic member, and the restriction member, the pawl member and the restriction member will not be detached from each other during assembly, so that the pawl member, the elastic member, and the restriction member are assembled in the second receiving recess easily.

According to another advantage of the present invention, the pawl member and the restriction member are connected, the pawl member and the elastic member are connected, and the elastic member and the restriction member are connected, so that the pawl member, the elastic member, and the restriction member are interconnected steadily.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a ratchet wrench in accordance with the preferred embodiment of the present invention.

FIG. 2 is a top view of a pawl member of the ratchet wrench in accordance with the preferred embodiment of the present invention.

FIG. 3 is a top view of a restriction member of the ratchet wrench in accordance with the preferred embodiment of the present invention.

FIG. 4 is a perspective view of the ratchet wrench in accordance with the preferred embodiment of the present invention.

FIG. 5 is a perspective view showing assembly of the pawl member and the restriction member of the ratchet wrench in accordance with the preferred embodiment of the present invention.

FIG. 6 is a side view of the ratchet wrench in accordance with the preferred embodiment of the present invention.

FIG. 7 is a cross-sectional view of the ratchet wrench taken along line A-A as shown in FIG. 6.

FIG. 8 is a schematic operational view of the ratchet wrench as shown in FIG. 7.

FIG. 9 is a top view of the ratchet wrench in accordance with the preferred embodiment of the present invention.

FIG. 10 is a cross-sectional view of the ratchet wrench taken along line B-B as shown in FIG. 9.

### DETAILED DESCRIPTION OF THE INVENTION

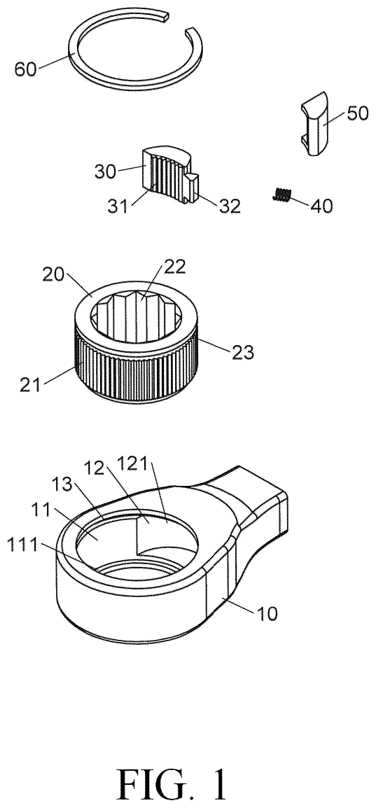

Referring to the drawings and initially to FIGS. 1-9, a ratchet wrench in accordance with the preferred embodiment of the present invention comprises a wrench body 10, a ratchet wheel 20, a pawl member 30, an elastic member 40, a restriction member 50, and a snap ring 60.

The wrench body 10 has an end provided with a first receiving recess 11 having a circular shape. The first receiving recess 11 has a bottom provided with an abutting edge 111. The wrench body 10 is provided with a second receiving recess 12 beside the first receiving recess 11. The second receiving recess 12 is connected to the first receiving recess 11. The second receiving recess 12 has a diameter less than that of the first receiving recess 11. The second receiving recess 12 has a center disposed in the first receiving recess 11. The second receiving recess 12 has a closed top and a closed bottom. The second receiving recess 12 is provided with a first peripheral face 121 having an arcuate shape. The first receiving recess 11 is provided with a first snap ring groove 13 having an annular shape. The first snap ring groove 13 is close to an opening of the first receiving recess 11.

The ratchet wheel 20 is rotatably mounted in the first receiving recess 11 and rests on the abutting edge 111. The ratchet wheel 20 has a periphery provided with a ratchet (or toothed) portion 21 having multiple teeth arranged annularly. The ratchet wheel 20 is provided with a mounting portion 22. Preferably, the mounting portion 22 is a polygonal hole. The ratchet wheel 20 is provided with a second snap ring groove 23 having an annular shape. The second snap ring groove 23 aligns with the first snap ring groove 13.

The pawl member 30 is received in the second receiving recess 12 and rests on a side of the second receiving recess 12. The pawl member 30 has a first side provided with multiple engaging teeth 31 engaging or meshing with the ratchet portion 21. The pawl member 30 has a periphery provided with a first protruding block 32 and a second protruding block 33. The first protruding block 32 is provided with a first face 321 directed toward the ratchet wheel 20. The second protruding block 33 is located beside the first protruding block 32. The second protruding block 33 has a cylindrical shape. The pawl member 30 has a second side provided with a second face 34 and a third face 35. The second face 34 rests on or presses the first peripheral face 121. The second face 34 has an arcuate shape. The second face 34 is distant from the second protruding block 33, with the third face 35 being disposed between the second protruding block 33 and the second face 34. The third face 35 has an arcuate shape or planar shape.

The elastic member 40 is received in the second receiving recess 12 and elastically presses the pawl member 30, so that the engaging teeth 31 meshes with the ratchet portion 21 exactly. The elastic member 40 is limited by the first protruding block 32 and is not detached from the second receiving recess 12. The elastic member 40 has an end mounted on the second protruding block 33. Preferably, the elastic member 40 is a spring.

The restriction member 50 is an arcuate block. The restriction member 50 is made of soft material. The restriction member 50 is slightly elastic. The restriction member 50 is formed by plastic injection molding. The restriction member 50 has a first side provided with a fourth face 51 directed toward the ratchet wheel 20. The restriction member 50 has a second side provided with a fifth face 52 abutting or pressing the first peripheral face 121. The restriction member 50 has a periphery provided with a receiving chamber 53 having a closed top and a closed bottom. The first protruding block 32 and the elastic member 40 are received in the receiving chamber 53. The elastic member 40 is elastically biased between the pawl member 30 and a wall of the receiving chamber 53. The second protruding block 33 is also received in the receiving chamber 53.

The first face 321 is spaced from and does not contact the ratchet wheel 20. The first face 321 has a planar shape or an arcuate shape. When the first face 321 is a curved face, the first face 321 has a diameter more than that of the first receiving recess 11, or the first face 321 and multiple tooth valleys of the engaging teeth 31 are connected to form a curved line. The fourth face 51 is spaced from and does not contact the ratchet wheel 20. The fourth face 51 has a planar shape or an arcuate shape. When the fourth face 51 is a curved face, the fourth face 51 has a diameter equal to that of the first face 321, or the fourth face 51 has a diameter more than that of the first face 321.

The snap ring 60 has a C-shaped profile. The snap ring 60 is slightly elastic. The snap ring 60 is received in the first snap ring groove 13 and the second snap ring groove 23, so that the ratchet wheel 20 is retained in the first receiving recess 11.

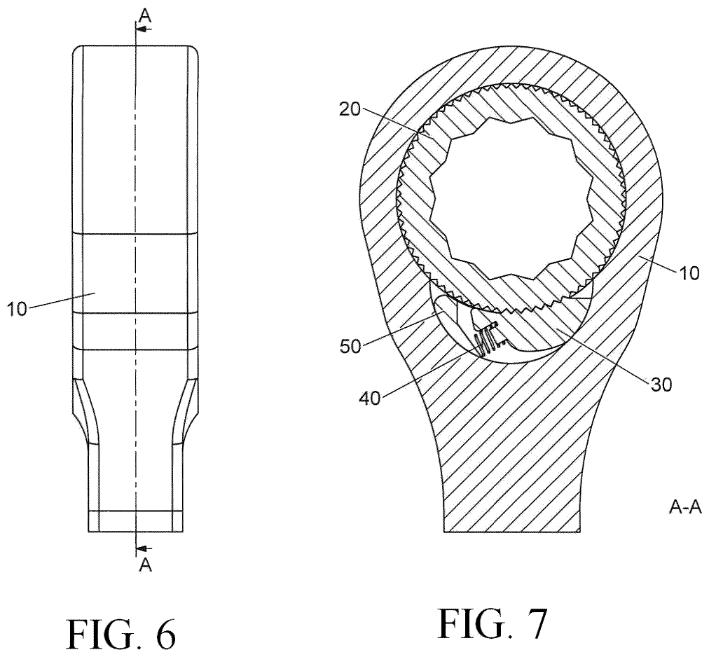

Referring to FIGS. 6 and 7 with reference to FIGS. 1-5, the ratchet wheel 20 is rotatably mounted in the first receiving recess 11, the pawl member 30 is received in the second receiving recess 12, and the second face 34 rests on the first peripheral face 121. The elastic member 40 is mounted on the second protruding block 33 and elastically biased between the pawl member 30 and the wall of the receiving chamber 53, so that the engaging teeth 31 engage the ratchet portion 21 exactly. The second face 34 rests on the first peripheral face 121, and the fifth face 52 also rests on the first peripheral face 121. In operation, when the wrench body 10 is rotated clockwise, the ratchet wheel 20 is driven by and rotated in concert with the wrench body 10.

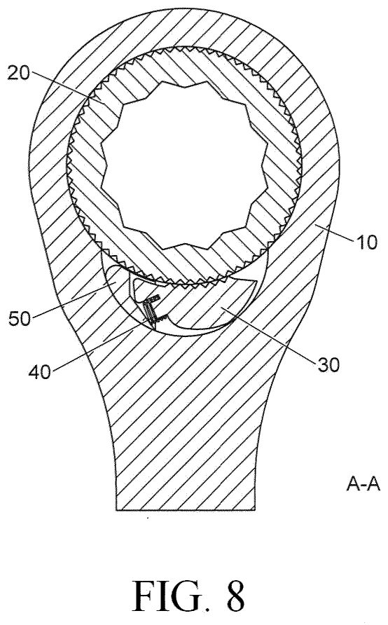

Referring to FIG. 8 with reference to FIGS. 1-7, when the wrench body 10 is rotated counterclockwise, the engaging teeth 31 disengage the ratchet portion 21. At this time, the pawl member 30 is moved leftward and rearward, and the first protruding block 32 and the elastic member 40 further extend into the receiving chamber 53, so that the elastic member 40 is compressed. Thus, the engaging teeth 31 is detached from the ratchet portion 21. At this time, the fourth face 51 may be moved to touch the ratchet portion 21 of the ratchet wheel 20 when the wrench body 10 is rotated counterclockwise.

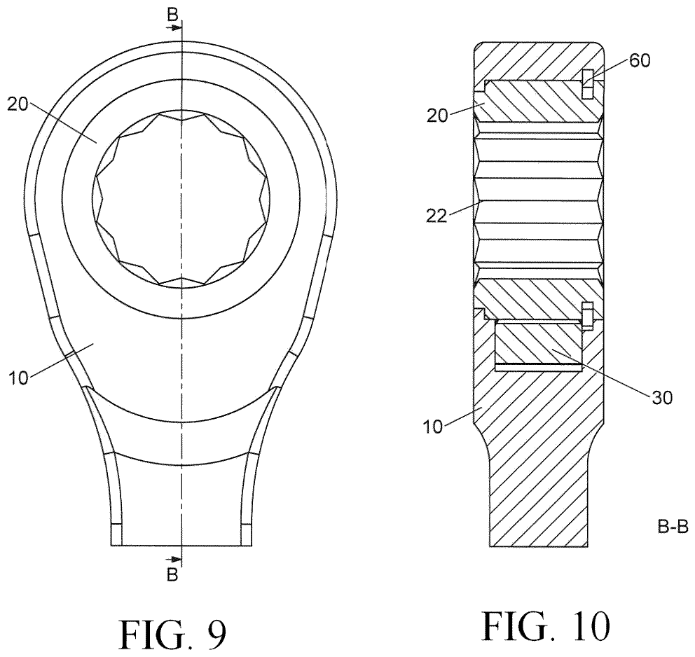

Referring to FIGS. 9 and 10 with reference to FIGS. 1-5, the snap ring 60 is accommodated between the first snap ring groove 13 and the second snap ring groove 23, so that the ratchet wheel 20 is retained in the first receiving recess 11 and will not be detached from the wrench body 10.

In another preferred embodiment of the present invention, the mounting portion 22 is a protruding square head. Alternatively, the mounting portion 22 may have various structures for mounting another tool. In addition, the second protruding block 33 is undefined, and the elastic member 40 directly presses the pawl member 30 elastically. Thus, the elastic member 40 is restricted by the first protruding block 32 and will not be detached from the second receiving recess 12.

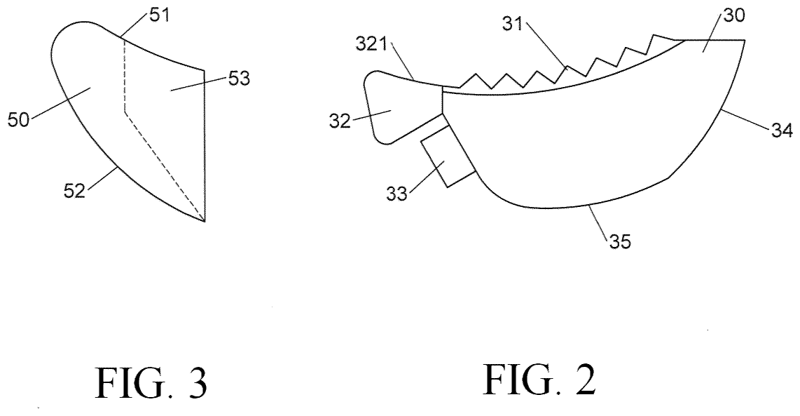

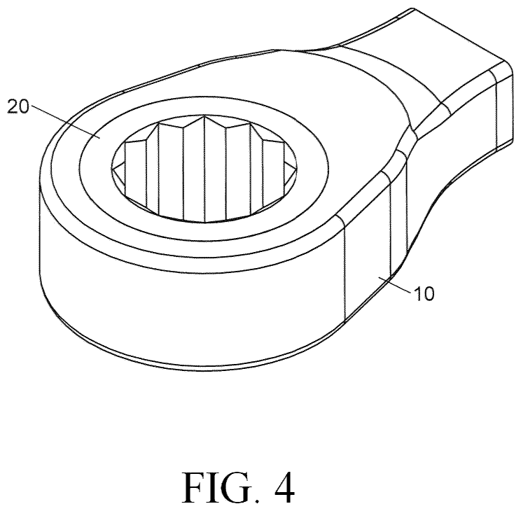

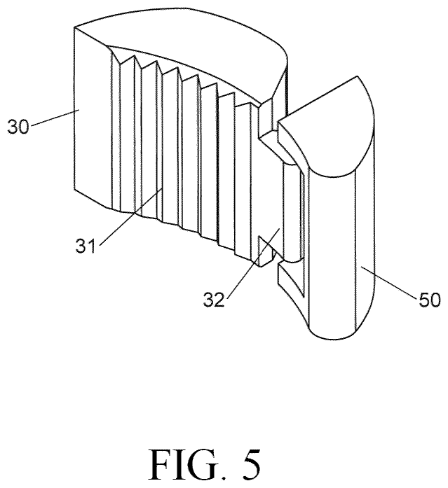

Accordingly, the ratchet wrench of the present invention has the following advantages.
1. Referring to FIG. 5, the pawl member 30 is provided with the first protruding block 32 assembled in the receiving chamber 53 of the restriction member 50, so that the pawl member 30 and the restriction member 50 are connected. The pawl member 30, the elastic member 40, and the restriction member 50 are assembled previously and are then mounted in the wrench body 10. Thus, when the user's hand holds the pawl member 30, the elastic member 40, and the restriction member 50, the pawl member 30 and the restriction member 50 will not be detached from each other during assembly, so that the pawl member 30, the elastic member 40, and the restriction member 50 are assembled in the second receiving recess 12 easily.
2. The pawl member 30 and the restriction member 50 are connected, the pawl member 30 and the elastic member 40 are connected, and the elastic member 40 and the restriction member 50 are connected, so that the pawl member 30, the elastic member 40, and the restriction member 50 are interconnected steadily.
3. The restriction member 50 is received in the second receiving recess 12 to limit the maximum movement of the pawl member 30 when the pawl member 30 is moved backward. Thus, if the pawl member 30 has a small movement distance when the pawl member 30 is moved backward, the pawl member 30 is easily moved forward.
4. The elastic member 40 is limited by the second protruding block 33 and will not be detached from the second receiving recess 12.
5. Referring to FIGS. 2 and 3, the pawl member 30 is provided with the first protruding block 32 and the second protruding block 33. The elastic member 40 has a first end mounted on the second protruding block 33 and a second end pressing the wall of the receiving chamber 53. Thus, the elastic member 40 is assembled easily.
6. The pawl member 30 is provided with the first protruding block 32 and the second protruding block 33 which are formed by metal injection molding without needing another working process.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A ratchet wrench comprising:
a wrench body, a ratchet wheel, a pawl member, an elastic member, a restriction member, and a snap ring;
wherein:
the wrench body has an end provided with a first receiving recess having a circular shape;
the first receiving recess has a bottom provided with an abutting edge;
the wrench body is provided with a second receiving recess beside the first receiving recess;
the second receiving recess is connected to the first receiving recess;
the second receiving recess has a diameter less than that of the first receiving recess;
the second receiving recess has a center disposed in the first receiving recess;
the second receiving recess has a closed top and a closed bottom;
the second receiving recess is provided with a first peripheral face having an arcuate shape;
the first receiving recess is provided with a first snap ring groove having an annular shape;
the first snap ring groove is close to an opening of the first receiving recess;
the ratchet wheel is rotatably mounted in the first receiving recess and rests on the abutting edge;
the ratchet wheel has a periphery provided with a ratchet portion having multiple teeth arranged annularly;
the ratchet wheel is provided with a mounting portion;
the ratchet wheel is provided with a second snap ring groove;
the second snap ring groove aligns with the first snap ring groove;
the pawl member is received in the second receiving recess and rests on a side of the second receiving recess;
the pawl member has a first side provided with multiple engaging teeth engaging the ratchet portion;
the pawl member has a periphery provided with a first protruding block and a second protruding block;
the first protruding block is provided with a first face directed toward the ratchet wheel;
the second protruding block is located beside the first protruding block;
the second protruding block has a cylindrical shape;
the pawl member has a second side provided with a second face and a third face;
the second face rests on the first peripheral face;
the second face has an arcuate shape;
the second face is distant from the second protruding block;
the third face has an arcuate shape or planar shape;
the elastic member is received in the second receiving recess and elastically presses the pawl member, so that the engaging teeth meshes with the ratchet portion;
the elastic member is limited by the first protruding block and is not detached from the second receiving recess;
the elastic member has an end mounted on the second protruding block;
the restriction member is an arcuate block;
the restriction member is made of soft material;
the restriction member is slightly elastic;
the restriction member is formed by plastic injection molding;
the restriction member has a first side provided with a fourth face directed toward the ratchet wheel;
the restriction member has a second side provided with a fifth face abutting the first peripheral face;
the restriction member has a periphery provided with a receiving chamber having a closed top and a closed bottom;
the first protruding block and the elastic member are received in the receiving chamber;
the elastic member is elastically biased between the pawl member and a wall of the receiving chamber;
the second protruding block is received in the receiving chamber;
the first face is spaced from the ratchet wheel;
the first face has a planar shape or an arcuate shape;
when the first face is a curved face, the first face has a diameter more than that of the first receiving recess, or the first face and multiple tooth valleys of the engaging teeth are connected to form a curved line;
the fourth face is spaced from the ratchet wheel;
the fourth face has a planar shape or an arcuate shape;
when the fourth face is a curved face, the fourth face has a diameter equal to that of the first face, or the fourth face has a diameter more than that of the first face;
the snap ring has a C-shaped profile;
the snap ring is slightly elastic; and
the snap ring is received in the first snap ring groove and the second snap ring groove, so that the ratchet wheel is retained in the first receiving recess.

2. The ratchet wrench as claimed in claim 1, wherein the elastic member is a spring.

3. The ratchet wrench as claimed in claim 1, wherein the mounting portion is a polygonal hole, or the mounting portion is a protruding square head, or the mounting portion may have various structures for mounting another tool.
